(19) United States
(12) Patent Application Publication
(10) Pub. No.: US 2026/0221492 A1
(43) Pub. Date: Jul. 30, 2026

(54) INTERFACE-FREE LOW-IMPEDANCE HIGH-SAFETY ALL-SOLID-STATE BATTERY AND PREPARATION METHOD THEREFOR

(71) Applicant: TIANNENG BATTERY GROUP CO., LTD., Huzhou, Zhejiang (CN)

(72) Inventors: Haiyuan ZHANG, Huzhou, Zhejiang (CN); Yu LI, Huzhou, Zhejiang (CN); Haimin ZHAO, Huzhou, Zhejiang (CN); Hao ZHANG, Huzhou, Zhejiang (CN); Guang HE, Huzhou, Zhejiang (CN)

(21) Appl. No.: 19/143,583

(22) PCT Filed: Dec. 29, 2022
(86) PCT No.: PCT/CN2022/143417

§ 371 Date: Jun. 26, 2025

(30) Foreign Application Priority Data
Dec. 26, 2022 (CN) 202211742110.6

(51) Int. Cl. H01M 10/056; H01M 10/0525

(52) U.S. Cl. CPC H01M 10/056; H01M 10/0525; H01M 2300/0065; H01M 2300/0091

(57) ABSTRACT

Provided in the present disclosure are an interface-free low-impedance high-safety all-solid-state battery and a preparation method therefor. In the present disclosure, uniform permeation and wetting is realized by means of a low-temperature method, and a temperature is maintained at 15° C. to 20° C., such that an electrolyte mixed solution before polymerization uniformly permeates into a positive electrode, a negative electrode, and a diaphragm of a battery cell; and then the temperature is gradually increased in a progressive manner, such that a second mixed solution undergoes a polymerization reaction. Therefore, the polymerization is uniform during in-situ polymerization, and a battery is low in interface impedance, good in consistency and stability, and high in first-time cycle efficiency. An all-solid-state battery having a unique interface-free stereoscopic net structure is manufactured, thereby improving the first-time cycle efficiency, and improving the overall electrochemical performance of the battery, and finally industrialization is easily realized.

### CROSS-REFERENCE TO RELATED APPLICATIONS

The present application is a National Stage of International Patent Application No. PCT/CN2022/143417 filed on Dec. 29, 2022, which claims priority to Chinese Patent Application No. 202211742110.6 filed on Dec. 26, 2022, the application of which is hereby incorporated by reference in its entirety.

### TECHNICAL FIELD

The present disclosure relates to the technical field of solid state batteries, and specifically, to an interface-free low-impedance high-safety all-solid-state battery and a preparation method therefor.

### BACKGROUND

The electrolyte is an important component of a lithium-ion battery. At present, the industry mainly uses liquid electrolytes. However, the liquid electrolytes require the use of adhesives and diaphragms, which generally reduces the energy density of liquid electrolyte batteries. Furthermore, the liquid electrolyte, which is typically prepared by organic molecules, is flammable, thus reducing the safety of the battery. At a low temperature, the liquid electrolyte gradually freezes, reducing ionic conductivity; and at a high temperature, the liquid electrolyte evaporates and produces high-impedance bubbles.

Due to these limitations of the liquid electrolyte, a solid electrolyte is increasingly attracting the attention of researchers as a potential alternative. Compared with the liquid electrolyte, the solid electrolyte achieves higher battery energy density by reducing battery mass and increasing an electrochemical window, is non-flammable, more stable within a temperature range, and does not leak under extreme temperatures or pressures. However, existing solid-state battery technologies are not yet mature enough to be commercialized. Existing preparation methods are either unoptimized or produce solid-state batteries with high interface impedance between an electrode and an electrolyte (and therefore rate and cycling performance being relatively poor).

The solid-state electrolyte is mainly prepared through in-situ polymerization, whereby a monomer, a lithium salt, a cross-linking agent, and an initiator compound are injected into the battery, and the electrolyte is solidified into a solid after heat is applied. By using such methods, since the monomer, the lithium salt, the cross-linking agent, and the initiator compound cannot be uniformly dispersed in the positive electrode, the negative electrode, and the diaphragm, and thus are dispersed non-uniformly therein, and in addition, temperature distribution in the battery is non-uniform, causing the in-situ polymerization reaction to be non-uniform, thus leading to a non-uniform solid electrolyte interface. Batteries produced in this method have poor consistency and stability, poor electrochemical performance, and high internal resistance, reducing the first cycle efficiency.

In addition to liquid injection and heating, there are other technologies using in-situ polymerization. Some technologies may initiate in-situ polymerization before assembling the battery. This may be achieved by coating an electrolyte material on a membrane to form an electrolyte membrane, and the membrane may have different compounds on both sides of the membrane, and then is adhered to an electrode, resulting in poor contact and high impedance at the electrode-electrolyte interface, ultimately reducing battery performance. In order to solve the above problem, one method is to mix a reactive monomer in the cathode and anode, then inject a cross-linking agent and initiator for in-situ polymerization. However, the solution still fails to solve the problem of non-uniform polymerization.

Considering the current lithium-ion battery industry, such as existing production lines, devices, and supply chains, the liquid injection solution of in-situ polymerization is the simplest and most convenient method for battery preparation, and also minimizes additional costs and promotes the development of solid-state batteries.

However, current study on in-situ polymerization has focused more on a theoretical structure of a material and the polymerization reaction, with little attention paid to the actual industrialization of the solid-state batteries, for example, liquid injection. There are also few solutions to problems that occur when using such methods, such as high interface impedance, non-uniform polymerization, poor battery consistency and stability, low first-time cycle efficiency, etc.

### SUMMARY

In views of the problems of high interface impedance, poor battery consistency and stability, low first-time cycle efficiency caused by non-uniform polymerization during in-situ polymerization of a solid-state battery in the related art, the present disclosure provides a method for preparing an interface-free low-impedance high-safety all-solid-state battery, as well as a prepared all-solid-state battery.

Provided is a method for preparing an interface-free low-impedance high-safety all-solid-state battery. The all-solid-state battery includes a battery cell. The preparation method includes the following steps.
(1) A reactive monomer, a cross-linking agent, and a lithium salt are well mixed to obtain a first mixed solution, and a temperature of the first mixed solution is reduced to 15° C.-20° C.
(2) A temperature of an initiator is further reduced to 15° C.-20° C., and then the initiator is added to the cooled first mixed solution for well mixing, so as to obtain a second mixed solution.
(3) The second mixed solution is injected in the battery cell at 15° C.-20° C., and 15° C.-20° C. is maintained for a certain period of time such that the second mixed solution soaks the battery cell.
(4) The temperature is gradually increased in a progressive manner such that the second mixed solution undergoes a polymerization reaction, so as to obtain an all-solid-state battery with a solid-state electrolyte.

Preferably, the reactive monomer includes at least one of the following: poly(ethylene glycol) methyl ether methacrylate, poly(ethylene glycol) dimethyl methacrylate, methacryloyloxypropyl terminated polydimethylsiloxane, monomethacryloyloxypropyl terminated polydimethylsiloxane, and poly (triethoxyvinylsilane). The reactive monomer is specially selected to produce a polymer having ionic conductivity and mechanical stability, which is common in the liquid lithium-ion battery industry.

More preferably, the reactive monomer is composed of at least two different monomers, at least one of which is amorphous and has a low glass transition temperature (Tg), for example, poly(ethylene glycol) methyl ether methacrylate (POEM), and poly(ethylene glycol) dimethyl methacrylate (PEGDMA). Preferably, the mass of the amorphous and low-Tg reactive monomer may account for 20%-50% of the total mass of the reactive monomer. By adding such amorphous and low-Tg reactive monomer, the ion transmission efficiency of a battery may be improved to a certain extent, which is manifested in improved electrical performance such as battery capacity, internal resistance, and the like.

Preferably, the cross-linking agent is mainly intended to connect a polymerization reaction long chain, so as to form a cross-linking network. The cross-linking agent includes at least one of the following: poly(ethylene glycol) diacrylate, trimethylolpropane trimethacrylate, pentaerythritol tetraacrylate, pentaerythritol triacrylate, ethoxylated trimethylolpropane triacrylate, and polyether polyacrylate.

The lithium salt is mainly intended to provide an ion transmission carrier for a system. The lithium salt includes at least one of the following: LiBF₄, LiBF₆, LiAF₆, LiPF₆, LiClO₄, LiB(C₆H₅)₄, LiAlCl₄, LiBr, LiCF₃O₃, LiN(CF₃O₂)₂, LiC(CF₃OO₂)₃, LiN(O₂C₂F₅)₂, and Li[B(O₄C₂)]₂.

The initiator is used to initiate the reactive monomer to undergo the polymerization reaction. The initiator is 2,2′-azobis(2-methylpropionitrile).

Preferably, by mass, for every 100 parts of the reactive monomer, 1-4 parts of the initiator, 12-24 parts of the lithium salt, and 20-40 parts of the cross-linking agent are added correspondingly.

After liquid injection, the second mixed solution needs to fully soak the battery cell. Preferably, in step (3), a soaking time is not less than 48 h. If the soaking time is longer, it is more beneficial for soaking. However, it is also necessary to consider that the reactive monomer and the initiator have already been added to the second mixed solution. Although the polymerization reaction can be slowed down at a lower temperature, the polymerization reaction may still occur. Therefore, more preferably, in step (3), the soaking time is 48-60 h.

In the present disclosure, when the battery after liquid injection is heated from a low temperature to a high polymerization temperature which promotes the polymerization reaction to occur, a too fast heating rate causes a temperature field in the system to be inconsistent, and the polymerization reaction may not realize uniform polymerization at the same time, accordingly resulting in relatively low electrical performance capacity of the battery and shortened cycle life.

However, if the heating time is relatively long, production efficiency is affected slightly, and production energy consumption and costs are also increased. Therefore, preferably, in step (4), during the polymerization reaction, the temperature is gradually increased at a heating rate not exceeding 1° C./h until the temperature reaches 60-80° C., and the temperature is held for not less than 24 h. More preferably, during the polymerization reaction, the temperature is gradually increased at a heating rate of 0.5-1° C./h until the temperature reaches 60-80° C. Most preferably, during the polymerization reaction, the temperature is gradually increased at the heating rate of 1° C./h until the temperature reaches 60-80° C.

Liquid injection may be repeatedly performed for a plurality of times during liquid injection, or may also complete at one time. Repeated liquid injection specifically refers to a cycle consisting of battery vacuum extraction and electrolyte solution injection. The entire liquid injection process undergoes two or more cycles, such that it may ensure that an electrolyte solution is in a negative pressure state during liquid injection, causing the electrolyte solution to permeate in electrode holes more easily, thereby improving overall soaking performance and liquid injection efficiency. Preferably, in step (3), when the second mixed solution is injected in the battery cell at 15° C.-20° C., an environmental dew point is controlled between −45° C. and −65° C., and a vacuum degree is controlled between −98 kPa and −2 kPa.

Preferably, after the polymerization reaction in step (4), first formation and first degassing are performed, then the solid-state electrolyte is aged, and second formation and second degassing are performed after the aging is completed.

The first formation step is intended to complete the reaction between the electrolyte and the electrode and form a stable solid electrolyte interface. Preferably, conditions for first formation include: a charging current being 0.01 C-0.5 C, and a charging time being 30 minutes-360 minutes.

The first degassing step is intended to collect and discharge a gas produced during first formation. Preferably, conditions for first degassing include: first degassing is performed for 1-20 times at a pressure ranging from −98 kPa to −2 kPa, with 1-20 s every time.

The second formation step is intended to further complete the formation of the interface between the electrode and the electrolyte. Preferably, conditions for second formation include: a charging current being 0.01 C-0.5 C, and charging is performed until a voltage reaches a rated voltage of 4.2 V.

The second degassing step is intended to collect and discharge a gas produced by the second formation reaction. Preferably, conditions for second degassing include: second degassing is performed for 1-20 times at a pressure ranging from −98 kPa to −2 kPa, with 1-20 s every time.

Aging is intended to cause an initial side reaction of the battery to fully react, and form stable and firm SEI films on surfaces of positive and negative electrode particles, causing the subsequent battery cycles to be performed stably. Conditions for aging include: a temperature being 45-80° C., and a time being 12-120 h.

The present disclosure further provides an interface-free low-impedance high-safety all-solid-state battery prepared by the preparation method mentioned above. The all-solid-state battery prepared in the present disclosure has the advantages of no interface, low impedance, and high safety.

Compared with the related art, the present disclosure solves the problems of non-uniform polymerization, high interface impedance, poor consistency and stability of a battery, and low first-time cycle efficiency during in-situ polymerization. Liquid injection only needs to be performed for one time. Uniform permeation and wetting are realized by means of a low-temperature method, and a temperature is maintained at 15° C.-20° C., such that an electrolyte mixed solution before polymerization uniformly permeates into a positive electrode, a negative electrode, and a diaphragm of a battery cell; and then the temperature is gradually increased in a progressive manner, such that a second mixed solution undergoes a polymerization reaction. Therefore, the polymerization reaction is uniformly performed in such heating mode, polymerization is uniform during in-situ polymerization, and a battery is low in interface impedance, good in consistency and stability, and high in first-time cycle efficiency. An all-solid-state battery having a unique interface-free stereoscopic net structure is manufactured, thereby improving the first-time cycle efficiency, and improving the overall electrochemical performance of the battery. Finally, due to the usage of common components, which are polymerized to form polymers, and devices, especially existing lithium-ion battery production devices, industrialization is easily realized.

### DETAILED DESCRIPTION OF THE EMBODIMENTS

A positive electrode plate, a negative electrode plate, and a diaphragm of a solid-state cylindrical battery prepared in the following examples are as follows.
1. An NCM811 electrode plate is prepared as a positive electrode by using a conventional lithium-ion battery preparation process, a silicon carbon electrode plate is prepared as a negative electrode by using the conventional lithium-ion battery preparation process, and a traditional porous polyethylene membrane with high porosity and having an alumina coating is cut into an appropriate size.

### Preparation of Positive Electrode:

A positive electrode slurry is coated on a positive electrode current collector aluminum foil, and is dried for 10 h at 70° C.-110° C. in a vacuum drying chamber. The electrode is then compacted by a roller press and then a composite positive electrode plate is obtained through slitting and punching processes.

An active component in the positive electrode slurry is NCM811, with a structural formula being LiNi_{0.8}Co_{0.1}Mn_{0.1}O₂. Furthermore, the material is a compound of a multiphase structure, a uniform solid-state electrolyte (Li_{1.4}Al_{0.4}Ti_{1.6}(PO₄)₃, hereinafter referred to as LATP) coating layer is coated on a surface, and a capacity is up to 210 mAh/g (0.5 C/0.5 C charging and discharging).

The active component in the positive electrode slurry accounts for 96.5% of the mass percentage of the positive electrode slurry; a mass ratio of the NCM811, a conductive agent, and a binder is 96.5:1.5:2; and the conductive agent is SP-acetylene black, and the binder is PVDF5130.

### Preparation of Negative Electrode:

A negative electrode slurry is coated on a negative electrode current collector aluminum foil, and is dried for 10 h at 70° C.-110° C. in the vacuum drying chamber. The electrode is then compacted by the roller press and then a composite negative electrode plate is obtained through the slitting and punching processes.

An active component in the negative electrode slurry is SiO/graphite, and a capacity is up to 450 mAh/g (0.5 C/0.5 C charging and discharging).

The active component in the negative electrode slurry accounts for 96% of the mass percentage of the negative electrode slurry; a mass ratio of the SiO/graphite, the conductive agent, and the binder is 96:1.5:2.5; and the conductive agent is SP-acetylene black, and the binder is CMC+SBR.

### Example 1

A method for preparing an interface-free solid-state cylindrical battery with low internal resistance and high safety was as follows.
1. A positive electrode plate, a negative electrode plate, and a diaphragm were respectively prepared.
2. The positive electrode plate, the negative electrode plate, and the diaphragm prepared in Step 1 were wrapped, assembled, and dried, so as to prepare a dry battery without liquid injection.
3. 6.25 g of a poly(ethylene glycol) methyl ether methacrylate (POEM) monomer, 6.25 g of a methacryloyloxypropyl terminated polydimethylsiloxane (PDMD) monomer, 1.5 g of LiPF₆, and 2.5 g of a polyether polyacrylate cross-linking agent were mixed to prepare a primary electrolyte, and the mixture was stirred for 4 hours. A temperature was reduced to 15° C., then 0.125 g of an initiator 2,2′-azobis(2-methylpropionitrile) was added, and the mixture was then continuously stirred for 4 hours.
4. The electrolyte prepared in Step 3 was injected in the dry battery prepared in Step 2. A dew point of a liquid injection environment was controlled at −60° C., and a vacuum degree was −90 kPa. The battery was soaked for 60 h at 15° C., then the temperature was slowly heated to 60° C. at a rate of 1° C./h, and the temperature was held for 24 h to cause the reaction to be uniformly performed and cause polymerization to be uniform during in-situ polymerization.
5. The polymerized battery prepared in Step 4 was subjected to formation and primary degassing. A charging current for formation was 0.01 C, and a charging time was 360 minutes. A vacuum degree for primary degassing was-98 kPa, gas exhaustion was performed for 1 time, and a gas exhaustion time was 20 s.
6. The battery cell prepared in Step 5 was subjected to aging at room temperature, secondary formation, secondary degassing, and capacity grading, so as to complete the preparation of a solid-state battery. An aging temperature was 45° C., and a time was 120 h. A charging current for secondary formation was 0.01 C, and charging was performed until a voltage reached a rated voltage of 4.2 V. A vacuum degree for secondary degassing was-2 kPa, gas exhaustion was performed for 20 times, and each gas exhaustion time was 20 s.
7. An electrochemical performance test was performed on the prepared solid-state battery to measure a capacity, internal resistance, a life cycle, rate capability, and high-temperature storage performance. The battery was also subjected to a safety test, for example, tests involving needle penetration and overcharging. No explosion or combustion was observed.

### Example 2

A method for preparing an interface-free solid-state square battery with low internal resistance and high safety was as follows.
1. A positive electrode plate, a negative electrode plate, and a diaphragm were respectively prepared.
2. The positive electrode plate, the negative electrode plate, and the diaphragm prepared in step 1 were wrapped, hot-pressed, assembled, and dried, so as to prepare a dry battery without liquid injection.
3. 5 g of a poly(ethylene glycol) methyl ether methacrylate (POEM) monomer, 5 g of a methacryloyloxypropyl terminated polydimethylsiloxane (PDMD) monomer, 2.4 g of LiPF₆, and 4 g of a polyether polyacrylate cross-linking agent were mixed to prepare a primary electrolyte, and the mixture was stirred for 4 hours. A temperature was reduced to 20° C., 0.2 g of an initiator 2,2′-azobis(2-methylpropionitrile) was added, and the mixture was then continuously stirred for 4 hours.
4. The electrolyte prepared in step 3 was injected in the dry battery prepared in step 2. A dew point of a liquid injection environment was controlled at −60° C., and a vacuum degree was-90 kPa. The battery was soaked for 48 h at 20° C., then the temperature was slowly heated to 60° C. at a rate of 1° C./h, and the temperature was held for 24 h to cause the polymerization reaction to be uniformly performed.
5. The battery cell after in-situ polymerization in step 4 was subjected to formation and primary degassing. A charging current for formation was 0.5 C, and a charging time was 30 minutes. A vacuum degree for primary degassing was-2 kPa, gas exhaustion was performed for 20 times, and each gas exhaustion time was 20 s.
6. The battery cell prepared in step 5 was subjected to aging at room temperature, secondary formation, secondary degassing, and capacity grading, so as to complete the preparation of a solid-state battery. Conditions for aging included: a temperature being 80° C., and a time being 12 h. Conditions for secondary formation included: a charging current being 0.5 C, and charging being performed until a voltage reaches a rated voltage of 4.2 V. A vacuum degree for secondary degassing was-98 kPa, gas exhaustion was performed for 1 time, and a gas exhaustion time was 1 s.
7. An electrochemical performance test was performed on the prepared solid-state battery to measure a capacity, internal resistance, a life cycle, rate capability, and high-temperature storage performance. The battery was also subjected to a safety test, for example, tests involving needle penetration and overcharging. No explosion or combustion was observed.

### Example 3

The overall method was the same as Example 1, except that the reactive monomer in step 3 was poly (triethoxyvinylsilane), with addition mass being 6.25 g; a lithium salt was LiCF₃O₃, with addition mass being 1.5 g; a cross-linking agent was also added; the cross-linking agent was pentaerythritol tetraacrylate, with addition mass being 1.25 g; a primary electrolyte was prepared through mixing; the mixture was stirred for 4 hours; and a temperature was reduced to 15° C., then 0.25 g of an initiator 2,2′-azobis(2-methylpropionitrile) was added, and the mixture was then continuously stirred for 4 hours. In step 4, the battery was soaked for 48 h at 15° C., then the temperature was slowly heated to 80° C. at a rate of 1° C./h, and the temperature was held for 24 h to cause the polymerization reaction to be uniformly performed.

### Example 4

The overall method was the same as Example 1, except that the reactive monomer in step 3 was poly(ethylene glycol) dimethyl methacrylate, with addition mass being 6.25 g; a lithium salt was LiBF₄, with addition mass being 1.5 g; a cross-linking agent was also added; the cross-linking agent was poly(ethylene glycol) diacrylate, with addition mass being 2.5 g; a primary electrolyte was prepared through mixing; the mixture was stirred for 4 hours; and a temperature was reduced to 15° C., then 0.125 g of an initiator 2,2′-azobis(2-methylpropionitrile) was added, and the mixture was then continuously stirred for 4 hours. In step 4, the battery was soaked for 48 h at 20° C., then the temperature was slowly heated to 70° C. at a rate of 1° C./h, and the temperature was held for 24 h to cause the polymerization reaction to be uniformly performed.

### Example 5

The overall method was the same as Example 1, except that in step 4, after liquid injection, the battery was controlled to soak for 60 h at 10° C.; then the temperature was slowly heated to 60° C. at a rate of 1° C./h, and was held for 24 h; and since the soaking temperature was too low, the soaking fluidity of the electrolyte solution was reduced, incomplete soaking might occur, and accordingly, the electrical performance capacity of the battery was relatively low.

### Example 6

The overall method was the same as Example 1, except that in step 4, after liquid injection, the battery was controlled to soak for 60 h at 25° C.; then the temperature was slowly heated to 60° C. at a rate of 1° C./h, and was held for 24 h; and since the soaking temperature was too high, the polymerization reaction might partially occur in advance, uniform polymerization could not be realized during in-situ polymerization, and accordingly, the electrical performance capacity of the battery was relatively low, and the cycle life was shortened.

### Example 7

The overall method was the same as Example 1, except that in step 4, after liquid injection, the battery was controlled to soak for 60 h at 15° C.; then the temperature was slowly heated to 60° C. at a rate of 2° C./h, and was held for 24 h; and a too fast heating rate caused a temperature field in the system to be inconsistent, the polymerization reaction might not realize uniform polymerization at the same time, accordingly resulting in relatively low electrical performance capacity of the battery and shortened cycle life.

### Example 8

The overall method was the same as Example 1, except that in step 4, after liquid injection, the battery was controlled to soak for 60 h at 15° C., then the temperature was slowly heated to 60° C. at a rate of 0.5° C./h, and was held for 24 h to cause the reaction to be uniformly performed and cause polymerization to be uniform during in-situ polymerization. However, since the heating time was relatively long, production efficiency was affected slightly, and production energy consumption and costs were also increased.

### Example 9

The overall method was the same as Example 1, except that in step 4, after liquid injection, the battery was controlled to soak for 60 h at 15° C.; then the battery was directly placed in a 60° C. temperature box; the temperature was held for 24 h; and a too fast heating rate caused a temperature field in the system to be inconsistent, the polymerization reaction might not realize uniform polymerization at the same time, accordingly resulting in relatively low electrical performance capacity of the battery and shortened cycle life.

### Example 10

The overall method was the same as Example 1, except that in step 4, after liquid injection, soaking was maintained for 60 h at room temperature; then the temperature was slowly heated to 60° C. at a rate of 1° C./h, and was held for 24 h; and similar to Example 6, since the soaking temperature was too high and the polymerization reaction had a heat releasing process, the polymerization reaction might partially occur in advance, uniform polymerization could not be realized during in-situ polymerization, and accordingly, the electrical performance capacity of the battery was relatively low, and the cycle life was shortened.

### Test Example 1

An electrochemical performance test was performed on the prepared solid-state battery to measure a capacity, internal resistance, a life cycle, rate capability, and high-temperature storage performance. The battery was also subjected to a safety test, for example, tests involving needle penetration and overcharging. No explosion or combustion was observed. Experiment results were shown in Table 1.

TABLE 1

| | | | | Number of |
|---|---|---|---|---|
| | | | | cycles of |
| | | Battery | First-time | battery |
| | Battery | internal | cycle | (capacity |
| | capacity | resistance | efficiency | retention |
| Example | (Ah) | (mΩ) | (%) | rate ≥80%) |
| Example 1 | 4.64 | 35.5 | 82 | 500 |
| Example 2 | 4.60 | 35.8 | 82 | 500 |
| Example 3 | 4.50 | 36.8 | 80 | 500 |
| Example 4 | 4.62 | 35.3 | 82 | 500 |
| Example 5 | 4.45 | 39.6 | 76 | 500 |
| Example 6 | 4.48 | 37.9 | 77 | 450 |
| Example 7 | 4.36 | 43.7 | 73 | 350 |
| Example 8 | 4.66 | 35.2 | 82 | 500 |
| Example 9 | 4.14 | 45.3 | 70 | 300 |
| Example 10 | 4.40 | 38.3 | 76 | 450 |

### RESULT ANALYSIS AND CONCLUSIONS

By comparing Example 3 with Example 1, it might be learned that, the amorphous reactive monomer having a low glass transition temperature (Tg) used in the present disclosure, for example, poly(ethylene glycol) methyl ether methacrylate (POEM) and poly(ethylene glycol) dimethyl methacrylate (PEGDMA), might improve the ion transmission efficiency of the battery to a certain extent, which was manifested in improved electrical performance such as battery capacity, internal resistance, and the like, and verified by the experiment results.

By comparing Example 5 with Example 1, it might be learned that, since the soaking temperature was too low, the soaking fluidity of the electrolyte solution was reduced, incomplete soaking might occur, and accordingly, the electrical performance capacity of the battery was relatively low.

By comparing Examples 6 and 10 with Example 1, it might be learned that, since the soaking temperature was too high, the polymerization reaction might partially occur in advance, uniform polymerization could not be realized during in-situ polymerization, and accordingly, the electrical performance capacity of the battery was relatively low, and the cycle life was shortened.

By comparing Examples 7 and 9 with Example 1, it might be learned that, a too fast heating rate caused a temperature field in the system to be inconsistent, the polymerization reaction might not realize uniform polymerization at the same time, accordingly resulting in relatively low electrical performance capacity of the battery and shortened cycle life. By comparing Example 8 with Example 1, it might be learned that, however, if the heating time was relatively long, production efficiency was affected slightly, and production energy consumption and costs were also increased.

Through the results in the examples, it can be learned that, uniform permeation and wetting are realized by means of a low-temperature method, and a temperature is maintained at 15° C.-20° C., such that an electrolyte mixed solution before polymerization uniformly permeates into a positive electrode, a negative electrode, and a diaphragm of a battery cell; and then the temperature is gradually increased in a progressive manner, such that a second mixed solution undergoes a polymerization reaction. Therefore, the polymerization reaction is uniformly performed in such heating mode, polymerization is uniform during in-situ polymerization, and a battery is low in interface impedance, good in consistency and stability, and high in first-time cycle efficiency.

What is claimed is:

1. A method for preparing an interface-free low-impedance high-safety all-solid-state battery, wherein the all-solid-state battery comprises a battery cell, and the preparation method comprises the following steps:
(1) well mixing a reactive monomer, a cross-linking agent, and a lithium salt to obtain a first mixed solution, and reducing a temperature of the first mixed solution to 15° C.-20° C.;
(2) further reducing a temperature of an initiator to 15° C.-20° C., and then adding the initiator to the cooled first mixed solution for well mixing, so as to obtain a second mixed solution;
(3) injecting the second mixed solution in the battery cell at 15° C.-20° C., and maintaining at 15° C.-20° C. for a certain period of time such that the second mixed solution soaks the battery cell; and
(4) gradually increasing the temperature in a progressive manner such that the second mixed solution undergoes a polymerization reaction, so as to obtain an all-solid-state battery with a solid-state electrolyte.

2. The preparation method according to claim 1, wherein the reactive monomer comprises at least one of the following: poly(ethylene glycol) methyl ether methacrylate, poly(ethylene glycol) dimethyl methacrylate, methacryloyloxypropyl terminated polydimethylsiloxane, monomethacryloyloxypropyl terminated polydimethylsiloxane, and poly (triethoxyvinylsilane);
the cross-linking agent comprises at least one of the following: poly(ethylene glycol) diacrylate, trimethylolpropane trimethacrylate, pentaerythritol tetraacrylate, pentaerythritol triacrylate, ethoxylated trimethylolpropane triacrylate, and polyether polyacrylate;
the lithium salt comprises at least one of the following: LiBF₄, LiBF₆, LiAF₆, LiPF₆, LiClO₄, LiB(C₆H₅)₄, LiAlCl₄, LiBr, LiCF₃O₃, LiN(CF₃O₂)₂, LiC(CF₃OO₂)₃, LiN(O₂C₂F₅)₂, and Li[B(O₄C₂)]₂; and
the initiator is 2,2′-azobis(2-methylpropionitrile).

3. The preparation method according to claim 1, wherein by mass, for every 100 parts of the reactive monomer, 1-4 parts of the initiator, 12-24 parts of the lithium salt, and 20-40 parts of the cross-linking agent are added correspondingly.

4. The preparation method according to claim 1, wherein in step (3), a soaking time is not less than 48 h.

5. The preparation method according to claim 4, wherein in step (3), the soaking time is 48-60 h.

6. The preparation method according to claim 1, wherein in step (4), during the polymerization reaction, the temperature is gradually increased at a heating rate not exceeding 1° C./h until the temperature reaches 60-80° C., and the temperature is held for not less than 24 h.

7. The preparation method according to claim 1, wherein in step (3), when the second mixed solution is injected in the battery cell at 15° C.-20° C., an environmental dew point is controlled between −45° C. and −65° C., and a vacuum degree is controlled between −98 kPa and −2 kPa.

8. The preparation method according to claim 1, wherein after the polymerization reaction in step (4), first formation and first degassing are performed, then the solid-state electrolyte is aged, and second formation and second degassing are performed after the aging is completed.

9. The preparation method according to claim 8, wherein conditions for first formation comprise: a charging current being 0.01 C-0.5 C, and a charging time being 30 minutes-360 minutes;
conditions for second formation comprise: a charging current being 0.01 C-0.5 C, and charging is performed until a voltage reaches a rated voltage of 4.2 V;
conditions for first degassing and second degassing comprise: performing first degassing and second degassing for 1-20 times at a pressure ranging from −98 kPa to −2 kPa, with 1-20 s every time; and
conditions for aging comprise: a temperature being 45-80° C., and a time being 12-120 h.

10. An interface-free low-impedance high-safety all-solid-state battery prepared by the preparation method according to claim 1.

11. The interface-free low-impedance high-safety all-solid-state battery according to claim 10, wherein the all-solid-state battery comprises a battery cell, the battery cell comprises an NCM811 electrode plate, a silicon carbon electrode plate, and a polyethylene membrane; and a battery capacity is 4.16-4.66 Ah, a battery internal resistance is 35.2-45.3 mΩ, a first-time cycle efficiency is 70-82%, a number of cycles of battery when capacity retention rate is ≥80% is 300-500.

12. The interface-free low-impedance high-safety all-solid-state battery according to claim 11, wherein the battery capacity is 4.5-4.64 Ah, the battery internal resistance is 35.3-36.8 mΩ, the first-time cycle efficiency is 80-82%, the number of cycles of battery when capacity retention rate is ≥80% is 500.

13. The preparation method according to claim 1, wherein in step (3), the second mixed solution is injected in the battery cell at 15° C., 16° C., 17° C., 18° C., 19° C., or 20° C.

14. The preparation method according to claim 1, wherein in step (3), a soaking time is 48 h, 50 h, 52 h, 54 h, 55 h, 58 h, or 60 h.

15. The preparation method according to claim 6, wherein in step (4), during the polymerization reaction, the temperature is gradually increased at a heating rate of 0.5-1° C./h until the temperature reaches 60-80° C.

16. The preparation method according to claim 6, wherein in step (4), during the polymerization reaction, the temperature is gradually increased at a heating rate of 0.5° C./h, 0.6° C./h, 0.7° C./h, 0.8° C./h, 0.9° C./h, or 1° C./h, until the temperature reaches 60-80° C.

17. The preparation method according to claim 2, wherein the reactive monomer comprises at least one of poly(ethylene glycol) methyl ether methacrylate and poly(ethylene glycol) dimethyl methacrylate.

18. The preparation method according to claim 17, wherein a mass of poly(ethylene glycol) methyl ether methacrylate and/or poly(ethylene glycol) dimethyl methacrylate accounts for 20-50% of a total mass of the reactive monomer.

19. The preparation method according to claim 1, wherein the reactive monomer comprises at least one of the following: poly(ethylene glycol) methyl ether methacrylate, poly(ethylene glycol) dimethyl methacrylate, methacryloyloxypropyl terminated polydimethylsiloxane, and poly(triethoxyvinylsilane).

20. The preparation method according to claim 1, wherein the cross-linking agent comprises at least one of the following: poly(ethylene glycol) diacrylate, pentaerythritol tetraacrylate, and polyether polyacrylate; the lithium salt comprises at least one of the following: LiBF₄, LiPF₆, and LiCF₃O₃.
